(19) United States
(12) Patent Application Publication
(10) Pub. No.: US 2026/0225531 A1
(43) Pub. Date: Aug. 6, 2026

(54) OCCUPANT MONITORING SYSTEM

(71) Applicant: Harman Becker Automotive Systems GmbH, Karlsbad-Ittersbach (DE)

(72) Inventors: Peter BRANDT, Pfinztal (DE); Ramazan Ferhat ÖLGÜN, München (DE); Sameel Kassim ISMAIL, Garching (DE)

(21) Appl. No.: 19/156,350

(22) PCT Filed: Mar. 7, 2023
(86) PCT No.: PCT/EP2023/055745

§ 371 Date: Aug. 13, 2025

(51) Int. Cl. B60R 1/29; G02F 1/133; G06V 20/59

(52) U.S. Cl. CPC B60R 1/29; G02F 1/13318; G06V 20/593

(57) ABSTRACT

An occupant monitoring system comprises a camera arranged on a first side of a display of a vehicle, wherein a field of view of the camera is directed towards and passes through the display, and a liquid crystal lens, wherein the liquid crystal lens is arranged between the camera and the display, or the display is arranged between the camera and the liquid crystal lens, and the field of view of the camera is directed towards and passes through the liquid crystal lens, the liquid crystal lens is configured to alter the field of view of the camera by steering an incident beam from a second side of the display at a desired angle towards the camera.

### TECHNICAL FIELD

The disclosure relates to an occupant monitoring system, in particular to an occupant monitoring system of a vehicle.

### BACKGROUND

Occupant monitoring systems are configured to monitor one or more occupants of a vehicle in order to, e.g., determine an occupant (e.g., driver) distraction level or an occupant (e.g., driver) attention level. This may be done by tracking the eyes of one or more occupants of a vehicle (e.g., of a driver and/or any other occupants of the vehicle), for example. Driver distraction or a reduced driver attention resulting from a distraction may increase the risk for accidents. Therefore, driver distraction has a huge impact on road safety. Distractions may be caused by the driver themselves, e.g., when using a phone while driving or when adjusting the settings of a navigation or entertainment system while driving. Drivers, however, may also be distracted when their attention is drawn to any unexpected events or occurrences that may happen along the route the driver is traveling. If, by means of an occupant monitoring system, it is detected that a driver of a vehicle is not looking ahead on the road but is gazing away from the road for long periods of time or very frequently, this may be an indication that the driver is distracted. Occupant monitoring systems can further determine whether a driver is becoming drowsy, e.g., if it is determined that the driver closes their eyes at an increased rate or for comparably long periods of time. Further applications for occupant monitoring systems are, e.g., occupant detection and classification, seat belt detection, life presence detection, manual distraction, etc. Hence, there is a need for an occupant monitoring system and a method that reliably monitor one or more occupant's eyes.

### SUMMARY

An occupant monitoring system includes a camera arranged on a first side of a display of a vehicle, wherein a field of view of the camera is directed towards and passes through the display, and a liquid crystal lens, wherein the liquid crystal lens is arranged between the camera and the display, or the display is arranged between the camera and the liquid crystal lens, and the field of view of the camera is directed towards and passes through the liquid crystal lens, the liquid crystal lens is configured to alter the field of view of the camera by steering an incident beam from a second side of the display at a desired angle towards the camera.

A vehicle includes a display and an occupant monitoring system, wherein the field of view of the camera is directed towards a passenger compartment of the vehicle.

A method for operating the occupant monitoring system includes capturing images by means of the camera at regular intervals, for each image captured by the camera, determining whether an object of interest is within the field of view of the camera by performing object recognition techniques, and if it is determined that the object of interest is not within the field of view of the camera, changing the refraction index of one or more different sections of the liquid crystal layer.

Other systems, methods, features and advantages will be or will become apparent to one with skill in the art upon examination of the following detailed description and figures. It is intended that all such additional systems, methods, features and advantages be included within this description, be within the scope of the invention and be protected by the following claims.

### BRIEF DESCRIPTION OF THE DRAWINGS

The arrangement may be better understood with reference to the following description and drawings. The components in the figures are not necessarily to scale, emphasis instead being placed upon illustrating the principles of the invention. Moreover, in the figures, like referenced numerals designate corresponding parts throughout the different views.

FIG. 1 schematically illustrates a vehicle comprising an occupant monitoring system.

FIG. 2 schematically illustrates an occupant monitoring system according to embodiments of the disclosure.

FIG. 3 schematically illustrates an occupant monitoring system according to further embodiments of the disclosure.

FIG. 4 schematically illustrates an occupant monitoring system according to even further embodiments of the disclosure.

FIG. 5 schematically illustrates an exploded view of the occupant monitoring system of FIG. 4.

FIG. 6 schematically illustrates an occupant monitoring system according to even further embodiments of the disclosure.

FIG. 7, in a flowchart, schematically illustrates a method according to embodiments of the disclosure.

### DETAILED DESCRIPTION

As required, detailed embodiments of the present invention are disclosed herein; however, it is to be understood that the disclosed embodiments are merely examples of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

It is recognized that directional terms that may be noted herein (e.g., “upper”, “lower”, “inner”, “outer”, “top”, “bottom”, etc.) simply refer to the orientation of various components of an arrangement as illustrated in the accompanying figures. Such terms are provided for context and understanding of the disclosed embodiments.

Referring to FIG. 1, a vehicle 10 is schematically illustrated. The vehicle 10 comprises an occupant monitoring system. The occupant monitoring system comprises a camera 30 arranged behind a display 20 of the vehicle 10. The display 20 may be arranged centrally within the dashboard of the vehicle 10, for example. The display 20, however, may also be arranged at any other position within the dashboard in front of a driver's seat of the vehicle 10. By arranging the camera 30 behind the display 20 (display 20 is arranged between the camera 30 and the passenger compartment of the vehicle 10), it is not visible for any occupants of the vehicle 10. Cameras that are visible for the occupants of a vehicle 10 are generally considered disturbing. The camera 30, therefore, is hidden behind the display 20 for design reasons.

A field of view of the camera 30 may be directed towards the passenger compartment (illustrated in dot-dashed lines in FIG. 1). An occupant monitoring system may be configured to detect the presence of one or more occupants, or whether or not the occupants of a vehicle are wearing a seatbelt, for example. One specific example of an occupant monitoring system is a driver monitoring system. In a driver monitoring system, the field of view of the camera 30 may be directed towards the driver's seat. That is, the area that is captured by a driver monitoring system may be smaller than the area captured by an occupant monitoring system. A driver monitoring system may be configured to track the eyes of a driver 102 seated on the driver's seat. The field of view of a camera 30, however, is generally restricted to a certain area. Different occupants and drivers of a vehicle may be different in size such that the head of one occupant or driver may be within the field of view of a camera directed towards typical head positions, while the head of other occupants or drivers may only be captured towards the edges of the field of view of the camera, or may be even outside the field of view of the camera. This may be the case as well for any other objects of interest that are to be captured by the camera 30. That is, depending on the specific position of an object of interest (e.g., a driver's head), the function of the occupant monitoring system (e.g., eye tracking performed by a driver monitoring system) may be satisfying in some situations, and insufficient for others. Therefore, according to embodiments of the disclosure, the field of view of the camera 30 is adjustable. This will be described in further detail below by means of a driver monitoring system. The general principles, however, similarly apply for any kind of occupant monitoring system.

In the following, the general principle of a driver monitoring system according to embodiments of the disclosure will be described with respect to a camera 30 directed towards a driver's seat (indicated in solid lines in FIG. 1). As is illustrated in dashed lines in FIG. 1, a driver monitoring system may optionally comprise additional cameras, e.g., a second camera 32 directed towards a front passenger seat and configured to capture images of the eyes of a passenger 104 seated on the front passenger seat. Everything that is described with respect to the camera 30 in the following equally applies for any additional cameras of the driver monitoring system (or of any other kind of occupant monitoring system).

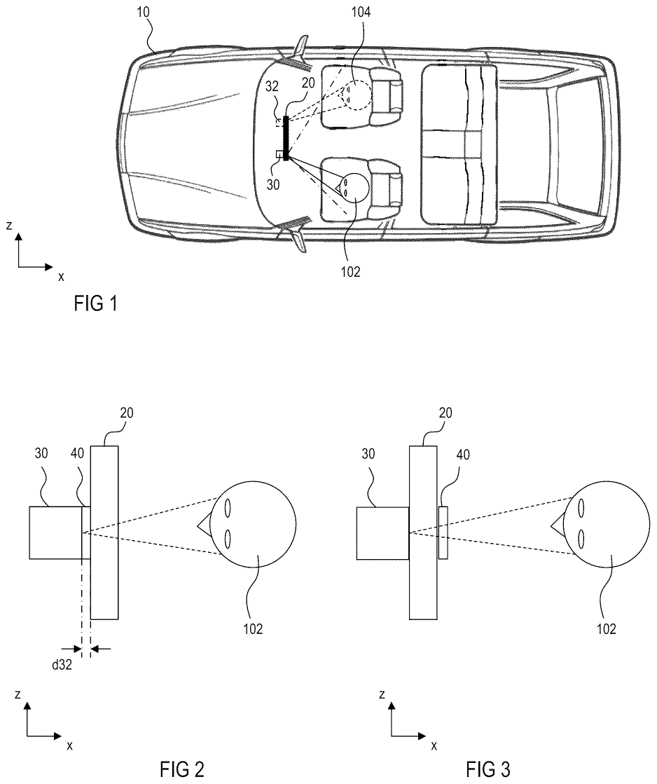

Now referring to FIGS. 2 and 3, driver monitoring systems according to embodiments of the disclosure are schematically illustrated. A driver monitoring system comprises a camera 30 arranged at a first side of a display 20, wherein a field of view of the camera is directed towards and passes through the display 20. A second side of the display faces the passenger compartment of the vehicle 10. When a driver 102 is seated on a driver's seat of the vehicle 10, the driver is arranged on a second side of the display 20 such that the display 20 is arranged between the driver 102 and the camera 30, thereby hiding the camera 30 behind the display 20. The driver monitoring system further comprises a liquid crystal lens 40, wherein either the liquid crystal lens 40 is arranged between the camera 30 and the display 20 (FIG. 2), or the display 20 is arranged between the camera 30 and the liquid crystal lens 40 (FIG. 3) such that the field of view of the camera 30 is directed towards and passes through the liquid crystal lens 40. In the example illustrated in FIG. 2, the liquid crystal lens 40 directly adjoins the camera 30 as well as the display 20. In the example illustrated in FIG. 3, the display 20 directly adjoins the camera 30 as well as the liquid crystal lens 40. This, however, are only examples. The different components do not necessarily have to directly adjoin each other. However, a distance between the different components may be comparably short, e.g., less than 1 cm (in a horizontal direction x). The liquid crystal lens 40 is configured to alter the field of view of the camera 30 by steering an incident beam at a desired angle towards the camera 30.

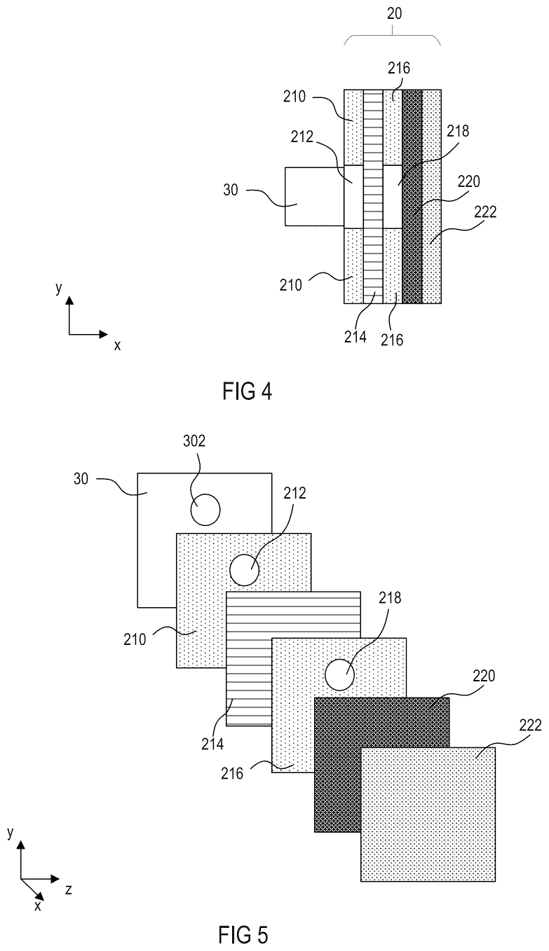

The display 20 may be an OLED display, for example. An OLED display is exemplarily illustrated in FIG. 4. The display 20 as illustrated in FIG. 4 comprises a cathode 210, a transparent cathode 212, an organic light emitting layer 214, an anode 216, and a transparent anode 218. The organic light emitting layer 214 is arranged between the cathodes (cathode 210 and transparent cathode 212) and the anodes (anode 216 and transparent anode 218). The display 20 may further comprise additional layers such as, e.g., a glass substrate layer 220 and a circular polarizer layer 222. The circular polarizer layer 222 may be configured to reduce reflections and increase a contrast of the display 20, as it diverts light that enters the display 20 from outside (from the second side of the display 20 facing the inside of the vehicle 10) and bounces back from the organic light emitting layer 214 and the (metal) cathode 210. The general structure and function of OLED displays is known and will not be described in further detail herein.

The cathode 210 and the anode 216 of an OLED display, however, are usually not transparent. The OLED display, therefore, would block the field of view of the camera 30 arranged behind the display 20. The OLED display as illustrated in FIG. 4, therefore, comprises a transparent cathode 212, and a transparent anode 218. The transparent cathode 212 and the transparent anode 218 are arranged in front of the camera 30 and within the field of view of the camera 30. The transparent cathode 212 may be arranged in the same plane as the cathode 210 and may be surrounded by the cathode 210. That is, the cathode 210 may have an opening and the transparent cathode 212 may be arranged in the opening formed in the cathode 210. The same applies for the anode 216 and the transparent anode 218. This is further schematically illustrated in the exploded view of FIG. 5. The transparent cathode 212 and the transparent anode 218 may have identical cross-sections (e.g., round, oval, square, rectangular cross-sections). The cross-sections of the transparent cathode 212 and the transparent anode 218 may further correspond to a cross-section of a lens 302 of the camera 30, for example. A cross-sectional area of the transparent cathode 212 and a cross-sectional area of the transparent anode 218 may equal or may be slightly larger than a cross-sectional area of the camera lens 302. In this way, the transparent cathode 212 and the transparent anode 218 are large enough to not block the field of view of the camera 30. However, a cross-sectional area of the transparent cathode 212 may be small as compared to the cross-sectional area of the cathode 210, and the cross-sectional area of the transparent anode 218 may be small as compared to the cross-sectional area of the anode 216. For example, a cross-sectional area of the cathode 210 and the anode 216 may be at least 50 times, at least 100 times, or at least 150 times the cross-sectional area of the transparent cathode 212 and the transparent anode 218, respectively.

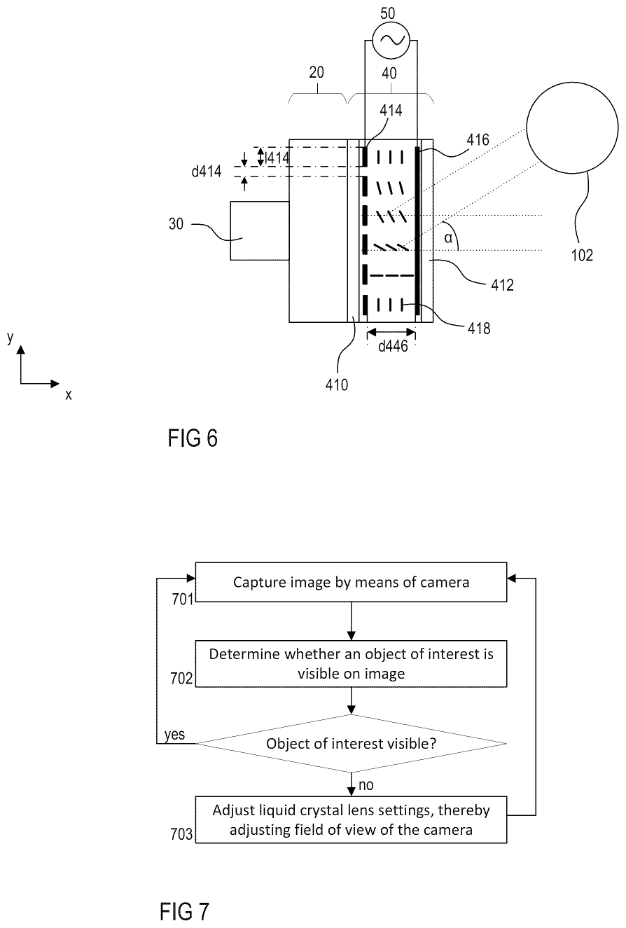

Now referring to FIG. 6, a liquid crystal lens 40 according to embodiments of the disclosure is described in further detail. The liquid crystal lens 40 comprises a first transparent electrode 414, a second transparent electrode 416, and a liquid crystal layer 418 comprising liquid crystal molecules arranged between the first transparent electrode 414 and the second transparent electrode 416. The first transparent electrode 414 and the second transparent electrode 416 may be indium-tin-oxide (ITO) conductive electrodes, for example. The liquid crystal lens 40 further comprises or is coupled to at least one AC voltage source 50 (only referred to as voltage source in the following) configured to apply an alternating voltage across the liquid crystal layer 418 between the first transparent electrode 414 and the second transparent electrode 416.

When no voltage is applied to the liquid crystal layer 418, the liquid crystal molecules are oriented in a first direction. For example, the liquid crystal molecules may be arranged perpendicular to the first and second transparent electrodes 414, 416. When a voltage is applied across the liquid crystal layer 418 (liquid crystal cells generally require that an alternating voltage be applied), the liquid crystal molecules in the liquid crystal layer 418 change their orientation. For example, the liquid crystal molecules may twist and tip towards a plane that is parallel to the first and second transparent electrode 414, 416. The resulting orientation of the liquid crystal molecules depends on the voltage that is applied across the liquid crystal layer 418. For example, the higher the voltage that is applied across the liquid crystal layer 418, the greater the change of orientation of the liquid crystal molecules with respect to their initial orientation (when no voltage is applied across the liquid crystal layer 418). Different orientations of the liquid crystal molecules are exemplarily illustrated in FIG. 6.

The liquid crystal layer 418 generally comprises a certain refraction index. For example, the liquid crystal layer 418, when no voltage is applied to the liquid crystal layer 418, may have an initial refraction index of 1.5 or more. Other refraction indexes are also possible. The refraction index, of a liquid crystal layer 418, however, generally depends on several different parameters. In particular, the refraction index of the liquid crystal layer 418 changes as a function of the voltage applied across the liquid crystal layer 418. That is, if a first voltage is applied to a first area of the liquid crystal layer 418 and a second voltage, which differs from the first voltage, is applied to a second area of the liquid crystal layer 418, the refraction index of the first area differs from the refraction index of the second area (due to the different orientations of the liquid crystal molecules in the respective areas).

In order to change the field of view of the camera 30, the driver or occupant monitoring system according to embodiments of the disclosure is configured to apply a varying voltage across the liquid crystal layer 418 such that the refraction index of the liquid crystal layer 418 is different for different sections of the liquid crystal layer 418. In this way, the liquid crystal lens 40 steers an incident beam at a desired angle towards the camera 30. This is schematically illustrated in FIG. 6. If, for example, no voltage is applied across the liquid crystal layer 418, the incident beam would go straight through the liquid crystal lens 40 (angle α=0°). By altering the voltage across the liquid crystal layer 418, thereby altering the refraction index of the liquid crystal layer 418, the incident beam is deviated (e.g., 0°<α>90°), thereby altering the direction of the field of view of the camera 30. By gradually changing the voltages applied across different sections of the liquid crystal layer 418, the incidence angle of the incidence beam (e.g., in a vertical direction y that is perpendicular to the field of view of the camera 30 and to a ground surface the vehicle 10 is traveling on) may be adjusted in any suitable way.

The liquid crystal lens 40 may further comprise a first glass substrate 410 and a second glass substrate 412, wherein the first transparent electrode 414, the liquid crystal layer 418, and the second transparent electrode are arranged between the first glass substrate 410 and the second glass substrate 412. The first glass substrate 410 and the second glass substrate 412 are transparent in order to not block the field of view of the camera 30. The first transparent electrode 414 may be developed (formed) on the first glass substrate 410, and the second transparent electrode 416 may be developed (formed) on the second glass substrate 412, for example.

According to embodiments of the disclosure, the occupant monitoring system may be configured to apply a varying voltage across the liquid crystal layer 418 which gradually increases or decreases from outer areas towards the center of the liquid crystal layer 418 such that the refraction index of the liquid crystal layer 418 gradually varies from outer areas towards the center of the liquid crystal layer 418. This, however, is only an example. Instead of gradually, the voltage may also increase or decrease rapidly and/or unevenly. By applying a suitable voltage profile to the liquid crystal layer 418, a suitable refraction index profile may be generated.

According to some embodiments of the disclosure, the first transparent electrode 414 comprises a plurality of separate electrode sub-sections, wherein each electrode sub-section can be controlled independently from each of the other electrode sub-sections. In this way, a voltage applied between each of the electrode sub-sections and the second transparent electrode 416 can be adjusted independently from each of the other electrode sub-sections. According to embodiments of the disclosure, each of the electrode sub-sections may be coupled to a different one of a plurality of voltage sources. It is, however, also possible to couple each of the plurality of electrode sub-sections to the same voltage source 50. In this case, a resistance between the voltage source 50 and each of the electrode sub-sections may be adjusted in a suitable way. E.g., a resistance coupled between the voltage source 50 and an electrode sub-section causes a voltage drop. By adjusting the resistance, the resulting voltage drop can be adjusted accordingly. A varying voltage profile, however, can also be generated by any other suitable means.

Each electrode sub-section may have a maximum dimension 1414 of between 1 μm and 3 μm, for example (e.g., maximum length and width). According to one example, a maximum dimension 1414 (e.g., maximum length and width) of each electrode sub-section is 1.5 μm. A distance d414 between an electrode sub-section and each of its directly neighboring electrode sub-sections may be between 0.2 μm and 1 μm, for example. According to one example, the distance d414 between an electrode sub-section and each of its directly neighboring electrode sub-sections is 0.5 μm. The electrode sub-sections may be arranged in rows and columns and may form an electrode array, for example. A distance d446 between the first transparent electrode 414 and the second transparent electrode 416 may be between 2 μm and 3 μm, for example. According to one example, the distance d446 between the first transparent electrode 414 and the second transparent electrode 416 is 2.5 μm.

When a driver 102 is seated in the driver's seat of a vehicle 10, a driver monitoring system initially does not know the correct settings for the liquid crystal lens 40, in order to be able to capture, e.g., the driver's eyes within the field of view of the camera 30. Therefore, the driver monitoring system may capture images by means of the camera at regular intervals (e.g., 10 images per second, or more). For each image captured by the camera 30, it may be determined whether the driver's eyes are within the field of view of the camera 30. This may be done by means of suitable eye recognition techniques, for example. Such techniques are commonly known and will not be described in further detail herein. If it is determined that a driver's eyes are not within the field of view of the camera 30, the refraction index of one or more different sections of the liquid crystal layer 418 may be changed. This may be done until the driver's eyes are visible on the images captured by the camera 30. If the driver 102 moves their head subsequently, the procedure may be repeated until the eyes are again within the field of view of the camera 30.

The method for operating a driver monitoring system as described above is merely one example. Generally speaking and with reference to FIG. 7, a method for operating an occupant monitoring system includes capturing images by means of the camera 30 at regular intervals (step 701), for each image captured by the camera 30, determining whether an object of interest is within the field of view of the camera 30 by performing object recognition techniques (step 702), and if it is determined that the object of interest is not within the field of view of the camera 30, changing the refraction index of one or more different sections of the liquid crystal layer 418 (step 703) before capturing the next image. If the object of interest is within the field of view of the camera 30, the next image may be captured without any adjustments of the liquid crystal lens settings.

The description of embodiments has been presented for purposes of illustration and description. Suitable modifications and variations to the embodiments may be performed in light of the above description or may be acquired from practicing the methods. The described arrangements are exemplary in nature, and may include additional elements and/or omit elements. As used in this application, an element recited in the singular and proceeded with the word “a” or “an” should not be understood as excluding the plural of said elements, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects. The described systems are exemplary in nature, and may include additional elements and/or omit elements. The subject matter of the present disclosure includes all novel and non-obvious combinations and sub-combinations of the various systems and configurations, and other features, functions, and/or properties disclosed. The following claims particularly disclose subject matter from the above description that is regarded to be novel and non-obvious.

1. An occupant monitoring system comprises:
a camera arranged on a first side of a display of a vehicle, wherein a field of view of the camera is directed towards and passes through the display; and
a liquid crystal lens, wherein
the liquid crystal lens is arranged between the camera and the display, or the display is arranged between the camera and the liquid crystal lens, and the field of view of the camera is directed towards and passes through the liquid crystal lens,
the liquid crystal lens is configured to alter the field of view of the camera by steering an incident beam from a second side of the display at a desired angle towards the camera.

2. The occupant monitoring system of claim 1, wherein the liquid crystal lens comprises:
a first transparent electrode;
a second transparent electrode;
a liquid crystal layer comprising liquid crystal molecules arranged between the first transparent electrode and the second transparent electrode; and
at least one AC voltage source configured to apply an alternating voltage across the liquid crystal layer between the first transparent electrode and the second transparent electrode, wherein
when a voltage is applied across the liquid crystal layer, the liquid crystal molecules in the liquid crystal layer change their orientation, thereby changing a refraction index of the liquid crystal layer, and
the occupant monitoring system is configured to apply a varying voltage across the liquid crystal layer such that the refraction index of the liquid crystal layer is different for different sections of the liquid crystal layer.

3. The occupant monitoring system of claim 2, wherein the liquid crystal lens further comprises a first glass substrate and a second glass substrate, wherein the first transparent electrode, the liquid crystal layer, and the second transparent electrode are arranged between the first glass substrate and the second glass substrate.

4. The occupant monitoring system of claim 2, wherein the first transparent electrode comprises a plurality of separate electrode sub-sections, wherein each electrode sub-section may be controlled independently from each of the other electrode sub-sections.

5. The occupant monitoring system of claim 4, wherein each electrode sub-sections has a maximum dimension of between 1 μm and 3 μm.

6. The occupant monitoring system of claim 4, wherein a distance between an electrode sub-section and each of its directly neighboring electrode sub-sections is between 0.2 μm and 1 μm.

7. The occupant monitoring system of claim 2, wherein a distance between the first transparent electrode and the second transparent electrode is between 2 μm and 3 μm.

8. A vehicle, comprising a display and an occupant monitoring system of claim 1, wherein the field of view of the camera is directed towards a passenger compartment of the vehicle.

9. The vehicle of claim 8, wherein the display comprises a cathode, a transparent cathode, an organic light emitting layer, an anode, and a transparent anode, wherein the organic light emitting layer is arranged between the cathode and the anode.

10. The vehicle of claim 9, wherein
the cathode comprises an opening, and the transparent cathode is arranged in the opening formed in the cathode such that it is arranged in the same plane as the cathode, and
the anode comprises an opening, and the transparent anode is arranged in the opening formed in the anode such that it is arranged in the same plane as the anode.

11. The vehicle of claim 10, wherein the transparent cathode and the transparent anode are arranged in front of a lens of the camera of the occupant monitoring system such that the field of view of the camera is directed towards and passes through the transparent cathode and the transparent anode.

12. The vehicle of claim 11, wherein
a cross-section of the transparent cathode and a cross-section of the transparent anode correspond to a cross-section of the lens of the camera, and
a cross-sectional area of the transparent cathode and a cross-sectional area of the transparent anode are equal to or are larger than a cross-sectional area of the lens of the camera.

13. The vehicle of claim 11, wherein
a cross-sectional area of the cathode is at least 50 times, at least 100 times, or at least 150 times the cross-sectional area of the transparent cathode, and
a cross-sectional area of the anode is at least 50 times, at least 100 times, or at least 150 times the cross-sectional area of the transparent anode.

14. The vehicle of claim 8, wherein the display is arranged within a dashboard of the vehicle.

15. A method for operating the occupant monitoring system of claim 1, wherein the method comprises,
capturing images by means of the camera at regular intervals;
for each image captured by the camera, determining whether an object of interest is within the field of view of the camera by performing object recognition techniques; and
if it is determined that the object of interest is not within the field of view of the camera, changing the refraction index of one or more different sections of the liquid crystal layer.
